(19) United States
(12) Patent Application Publication
(10) Pub. No.: US 2026/0181002 A1
(43) Pub. Date: Jun. 25, 2026

(54) SYSTEMS AND METHODS FOR DETERMINING ANOMALIES USING MACHINE LEARNING MODELS

(71) Applicant: Protiviti Inc., Menlo Park, CA (US)

(72) Inventors: Vandna Pruthi AHUJA, Columbus, OH (US); Min WU, Bayonne, NJ (US); Suresh Chandra BARAL, East Brunswick, NJ (US)

(73) Assignee: Protiviti Inc., Menlo Park, CA (US)

(21) Appl. No.: 18/987,425

(22) Filed: Dec. 19, 2024

(51) Int. Cl. H04L 9/40

(52) U.S. Cl. CPC H04L 63/1425; H04L 63/1441

(57) ABSTRACT

The present disclosure relates to systems and methods for determining anomalies using machine learning models. In examples, systems can be configured to receive network operation data representing a plurality of network operations. The system can classify a subset of the network operations as comprising an anomaly using an isolation forest model. The system can then determine, for each network operation of the subset of network operations, that the anomaly is a positive anomaly, a negative anomaly, or noise. In some examples, the systems can be configured to generate a graphical user interface (GUI) comprising a warning message, the warning message identifying at least one network operation of the subset of network operations as being a negative anomaly.

### FIELD OF THE DISCLOSURE

This disclosure generally relates to systems and methods for determining anomalies using machine learning models and, in some examples, to systems and methods that implement techniques for determining anomalies using machine learning models when detecting different types of anomalies.

### BACKGROUND OF THE DISCLOSURE

Traditional anomaly detection systems implemented to detect (among other things) fraudulent activity have largely relied on rule-based approaches, where electronic communications (e.g., messages containing data and/or the like that are passed between devices through one or more networks) are flagged as anomalies that can be indicative of such fraud based on predefined criteria. However, these systems often fail to adapt to new and evolving types of anomalies, leading to a high number of false positives and negatives. These systems also require constant updating to remain effective when detecting and analyzing these anomalous electronic communications. With the advent of digital transformation across industries, the complexity and volume of electronic communications within private and/or public networks has increased exponentially, rendering these conventional systems increasingly ineffective or otherwise unable to handle electronic communications.

### BRIEF SUMMARY OF THE DISCLOSURE

The present disclosure provides systems and methods for determining anomalies across electronic communications using machine learning models.

In an aspect, a system is disclosed. The system can include one or more processors. The one or more processors can be configured to receive network operation data representing a plurality of network operations processed by a communications network; classify, using an isolation forest model and the network operation data, a subset of network operations from among the plurality of network operations as including an anomaly; and determine, for each network operation of the subset of network operations, that the anomaly is a positive anomaly, a negative anomaly, or noise. In some implementations, the one or more processors can be configured to generate, at a client device, a graphical user interface (GUI) including a warning message, the warning message identifying at least one network operation of the subset of network operations as being a negative anomaly.

In some aspects, the one or more processors can be further programmed to: execute a set of preprocessing operations on the network operation data based on receiving the network operation data; determine one or more updates to network operations of the plurality of network operations based on the execution of the set of preprocessing operations; and update the network operation data based on the one or more updates to the network operations.

In some aspects, the one or more processors configured to classify the subset of network operations can be configured to: provide the network operation data to the isolation forest model to cause the isolation forest model to generate an anomaly score for each network operation, and determine that each network operation of the subset of network operations has an anomaly score that satisfies an anomaly score threshold; and determine the subset of network operations based on determining that each network operation satisfying the anomaly score threshold.

In some aspects, the one or more processors configured to determine, for each network operation of the subset of network operations, that the anomaly is a positive anomaly, a negative anomaly, or noise can be configured to: determine, for each network operation that is associated with a negative anomaly, that the anomaly score corresponds to a cluster associated with negative anomalies. In some implementations, the one or more processors configured to generate the GUI including the warning message can be configured to: generate the GUI including the warning message based on determining that the anomaly score corresponds to the cluster associated with the negative anomalies.

In some aspects, the one or more processors configured to determine, for each network operation that is associated with a negative anomaly, that the anomaly score corresponds to a cluster associated with negative anomalies can be configured to: determine, for each network operation that is associated with a negative anomaly, that one or more features correspond to a cluster of network operations involving synthetic fraud.

In some aspects, the one or more processors configured to determine, for each network operation of the subset of network operations, that the anomaly is a positive anomaly, a negative anomaly, or noise can be configured to: determine, for each network operation that is associated with a positive anomaly, that the anomaly score corresponds to a cluster associated with positive anomalies In some implementations, the one or more processors configured to generate the GUI including the warning message can be configured to: generate the GUI including the warning message based on determining that the anomaly score corresponds to the cluster associated with the positive anomalies.

In some aspects, the one or more processors can be further configured to: determine a global feature importance (GFI) score and a local feature importance (LFI) score for each feature associated with the isolation forest model; and determine a plurality of clusters based on the GFI score and the LFI score for each feature associated with the isolation forest model.

In another embodiment, a method for isolating network operations processed using a distributed computing environment is disclosed. The method can include receiving, by one or more processors, network operation data representing a plurality of network operations processed by a communications network; classifying, by the one or more processors and using an isolation forest model and the network operation data, a subset of network operations from among the plurality of network operations as including an anomaly; determining, by the one or more processors and for each network operation of the subset of network operations, that the anomaly is a positive anomaly, a negative anomaly, or noise. In some implementations, the method can include generating, by the one or more processors and at a client device, a graphical user interface (GUI) including a warning message, the warning message identifying at least one network operation of the subset of network operations as being a negative anomaly.

In some aspects, the method can further include executing, by the one or more processors, a set of preprocessing operations on the network operation data based on receiving the network operation data; determining, by the one or more processors, one or more updates to network operations of the plurality of network operations based on the execution of the set of preprocessing operations; and updating, by the one or more processors, the network operation data based on the one or more updates to the network operations.

In some aspects, classifying the subset of network operations can include providing, by the one or more processors, the network operation data to the isolation forest model to cause the isolation forest model to generate an anomaly score for each network operation, determining, by the one or more processors, that each network operation of the subset of network operations has an anomaly score that satisfies an anomaly score threshold; and determining, by the one or more processors, the subset of network operations based on determining that each network operation satisfying the anomaly score threshold.

In some aspects, determining that the anomaly is a positive anomaly, a negative anomaly, or noise can include determining, by the one or more processors and for each network operation that is associated with a negative anomaly, and that the anomaly score corresponds to a cluster associated with negative anomalies. In some implementations, generating the GUI including the warning message can include generating, by the one or more processors, the GUI including the warning message based on determining that the anomaly score corresponds to the cluster associated with the negative anomalies.

In some aspects, determining that the anomaly score corresponds to a cluster associated with negative anomalies can include determining, by the one or more processors and for each network operation that is associated with a negative anomaly, that one or more features correspond to a cluster of network operations involving synthetic fraud.

In some aspects, determining that the anomaly is a positive anomaly, a negative anomaly, or noise can include determining, by the one or more processors and for each network operation that is associated with a positive anomaly, that the anomaly score corresponds to a cluster associated with positive anomalies. In some implementations, generating the GUI including the warning message can include generating, by the one or more processors, the GUI including the warning message based on determining that the anomaly score corresponds to the cluster associated with the positive anomalies.

In some aspects, the method can further include determining, by the one or more processors, a global feature importance (GFI) score and a local feature importance (LFI) score for each feature associated with the isolation forest model; and determining, by the one or more processors, a plurality of clusters based on the GFI score and the LFI score for each feature associated with the isolation forest model.

In yet another embodiment, a non-transitory computer-readable medium storing instructions thereon is disclosed. The instructions, when executed by one or more processors, can cause the one or more processors to: receive network operation data representing a plurality of network operations processed by a communications network; classify, using an isolation forest model and the network operation data, a subset of network operations from among the plurality of network operations as including an anomaly; determine, for each network operation of the subset of network operations, that the anomaly is a positive anomaly, a negative anomaly, or noise. In some implementations, the instructions can cause the one or more processors to generate, at a client device, a graphical user interface (GUI) including a warning message, the warning message identifying at least one network operation of the subset of network operations as being a negative anomaly.

In some aspects, the instructions can further cause the one or more processors to: execute a set of preprocessing operations on the network operation data based on receiving the network operation data; determine one or more updates to network operations of the plurality of network operations based on the execution of the set of preprocessing operations; and update the network operation data based on the one or more updates to the network operations.

In some aspects, the instructions that cause the one or more processors to classify the subset of network operations can cause the one or more processors to: provide the network operation data to the isolation forest model to cause the isolation forest model to generate an anomaly score for each network operation, and determine that each network operation of the subset of network operations has an anomaly score that satisfies an anomaly score threshold; and determine the subset of network operations based on determining that each network operation satisfying the anomaly score threshold.

In some aspects, the instructions that cause the at least one model to determine that the anomaly is a positive anomaly, a negative anomaly, or noise can cause the one or more processors to: determine, for each network operation that is associated with a negative anomaly, that the anomaly score corresponds to a cluster associated with negative anomalies. In some implementations, the instructions that cause the one or more processors to generate the GUI can cause the one or more processors to: generate the GUI including the warning message based on determining that the anomaly score corresponds to the cluster associated with the negative anomalies.

In some aspects, the instructions that cause the one or more processors to determine that the anomaly score corresponds to a cluster associated with negative anomalies can cause the one or more processors to: determine, for each network operation that is associated with a negative anomaly, that one or more features correspond to a cluster of network operations involving synthetic fraud.

In some aspects, the instructions that cause the one or more processors to determine that the anomaly is a positive anomaly, a negative anomaly, or noise can cause the one or more processors to: determine, for each network operation that is associated with a positive anomaly, that the anomaly score corresponds to a cluster associated with positive anomalies. In some implementations, the instructions that cause the one or more processors to generate the GUI including the warning message can cause the one or more processors to: generate the GUI including the warning message based on determining that the anomaly score corresponds to the cluster associated with the positive anomalies.

By virtue of the implementation of techniques by the systems and methods described herein, such systems can be configured to analyze network traffic and determine whether one or more network operations represented by the network traffic are indicative of specific types of anomalies. For example, in the context of fraud detection, a system can be configured to analyze network operations that represent transactions involving multiple devices controlled by multiple parties. In cases where network operations are not fraudulent, the systems can be configured to analyze the network operations, determine that they are not anomalous, and forgo taking remedial action. In other cases where network operations represent transactions that involve anomalies and can be fraudulent, the systems can be configured to analyze and identify the various network operations as either positive anomalies (e.g., transactions that are outliers but are identifiable with a given individual (customer) and are identifiable with legitimate actions such as transactions involving a customer that is routine), negative anomalies (e.g., transactions that are outliers and may have been engineered by malicious individuals to evade conventional anomaly detection systems in accordance with synthetic fraud techniques described herein), or noise (e.g., transactions that may include typographical errors, etc., that are corrected and do not represent malicious activity). The systems can then dynamically generate and transmit GUI data associated with a GUI to cause devices to generate the GUI, where the GUI includes a warning that one or more network operations are potentially fraudulent. While the present disclosure is discussed in the context of certain types of network operations, it will be understood that the techniques described herein can be applied to multiple domains such as, for example, cybersecurity domains where messages passed through a network can be updated in accordance with the synthetic fraud techniques described herein to attempt to gain entry to systems or the like.

Systems that implement the techniques described herein can more accurately determine whether a given network operation or set of network operations represent anomalies indicative of malicious network activity and in some cases, initiate remedial action to reduce or eliminate the affects of these malicious network operations. For example, systems described herein can be configured to classify network operations as anomalies included various categories and further analyze their root causes. In doing so, the system can identify a subset or subsets of anomalies as anomalies that were previously unknown (e.g., are emerging risks) and can require further investigation or action due to their potential impact on system resource consumption, etc. This classification allows the system to differentiate between anomalies that are benign, known, or emerging risks. This, in turn, can reduce or eliminate negative effects (e.g., computing resource consumption, financial resource consumption, or the like) associated with continued processing of these malicious network operations. Further, as network operations scale and it becomes increasingly difficult to implement human-based or automated review of the network operations to determine whether they are malicious, the present disclosure can allow for the filtering of network operations to improve detection precision such that only a subset of anomalous network operations are processed that have a higher probability of being malicious. This, again, can conserve computing resources involved in processing these network operations, including network resources involved in further communication of messages between devices in a network that would otherwise hinder or delay the transmission of non-anomalous or anonymous but non-malicious network operations.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device for determining anomalies using machine learning models, in accordance with some embodiments;

FIG. 1B is a block diagram depicting a cloud computing environment comprising client device in communication with cloud service providers for determining anomalies using machine learning models, in accordance with some embodiments;

FIGS. 1C and 1D are block diagrams depicting embodiments of computing devices useful in connection with the methods and systems described herein.

FIG. 2 is a block diagram depicting a data processing system that is configured to determine anomalies using machine learning models while interfacing with related systems, in accordance with some embodiments.

FIG. 3 is a flow diagram of a process for analyzing and classifying network operations, in accordance with some embodiments.

FIG. 4 is a table including example multiple entries that are transformed in accordance with synthetic fraud techniques, in accordance with some embodiments.

FIG. 5 is an example of evaluation criteria for evaluating network operations, in accordance with some embodiments.

FIG. 6 is an example distribution of clusters of network operations that can be involved in synthetic fraud, in accordance with some embodiments.

FIG. 7 is a is a flow diagram of a method for analyzing and classifying network operations, in accordance with some embodiments.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein.
Section B describes embodiments of systems and methods for determining anomalies using machine learning models.

### A. Computing and Network Environment

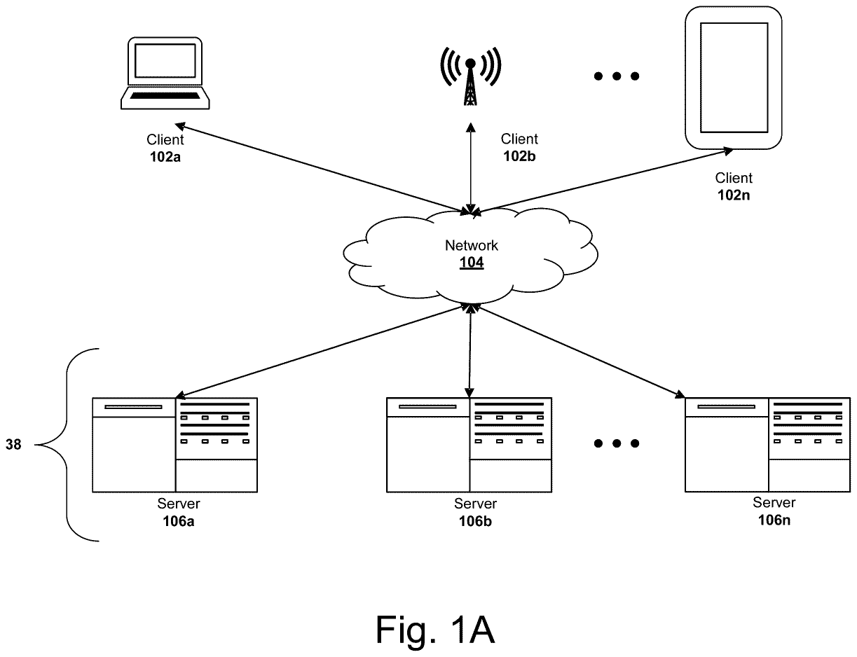

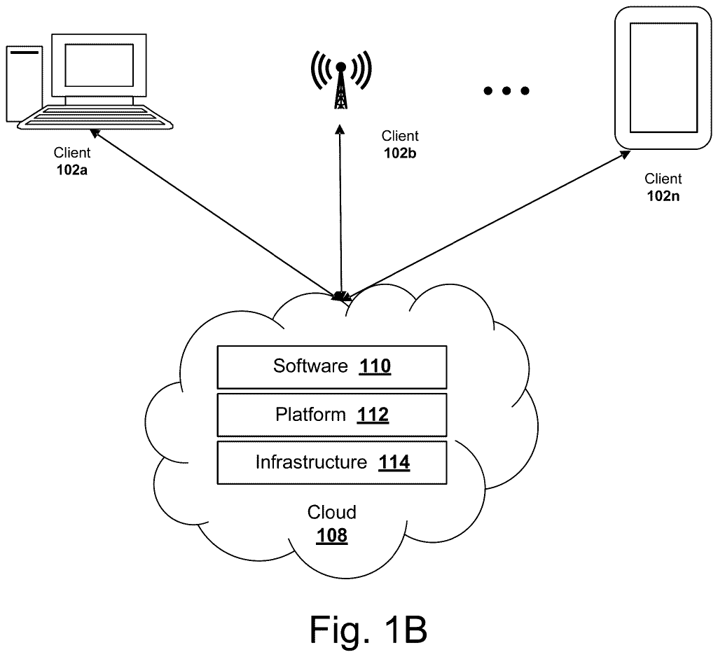

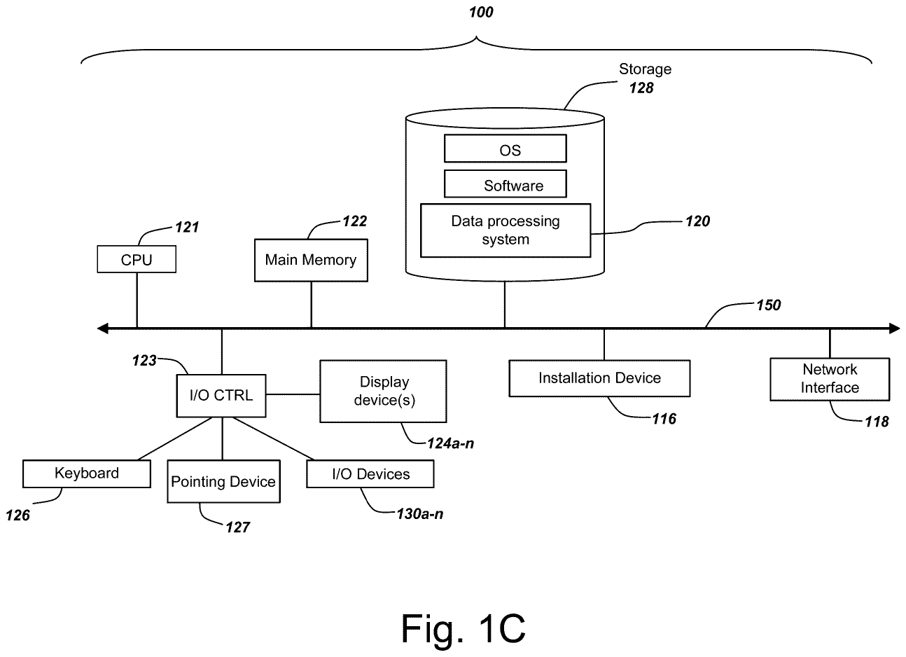

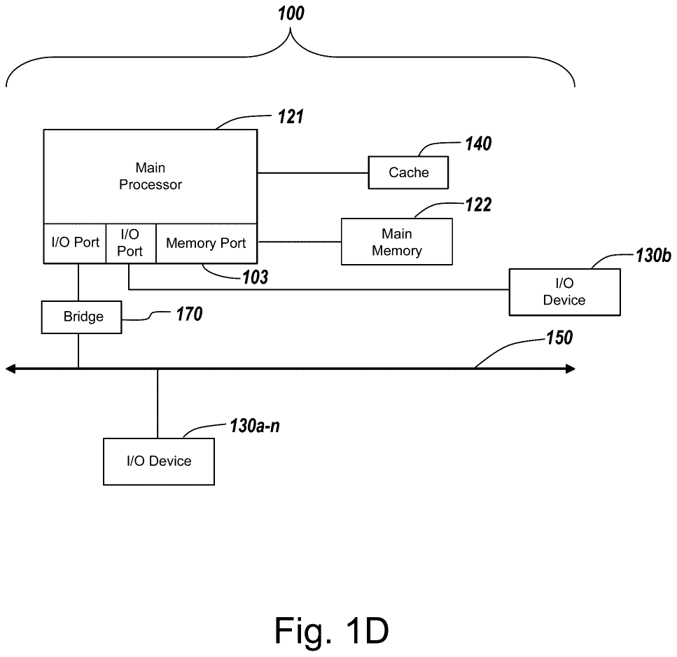

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 5G The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g., FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104'. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS Server 2019 or Windows Server 2022, manufactured by Microsoft Corp. of Redmond, Washington), while one or more of the other servers 106 can operate on according to another type of operating system platform (e.g., Unix, Linux, or Mac OS X).

In some embodiments, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, California; the Xen hypervisor, an open-source product whose development is overseen by Citrix Systems, Inc. ; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In some embodiments, the server 106 may be referred to as a remote machine or a node. In another embodiment, a plurality of nodes 106 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with a cloud environment 108 (referred to as a cloud 108) over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back-end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud-based delivery, e.g., Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon. com, Inc., of Seattle, Washington, RACKSPACE CLOUD provided by Rackspace US, Inc., of San Antonio, Texas, or Google Compute Engine provided by Google Inc. of Mountain View, California. PaaS providers may offer functionality provided by IaaS, including, e.g., storage, networking, servers or virtualization, as well as additional resources such as, e.g., the operating system, middleware, or runtime resources. Examples of PaaS include Microsoft AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce. com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft OneDrive provided by Microsoft Corporation, Google Drive provided by Google Inc., or Apple ICLOUD provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g., GOOGLE CHROME, or Mozilla Firefox provided by Mozilla Foundation of Mountain View, California). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g., a mouse. The storage device 128 may include, without limitation, an operating system, software, and a software of a data processing system 200. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to, and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above-described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g., a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g., stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In some embodiments, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in some embodiments, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g., one or more hard disk drives or redundant arrays of independent disks) for storing an operating system or other related software, and for storing application software programs such as any program related to the data processing system 120 for the experiment tracker system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage devices 128 may be non-volatile, mutable, or read-only. Some storage devices 128 may be internal and connect to the computing device 100 via a bus 150. Some storage devices 128 may be external and connect to the computing device 100 via a I/O device 130 that provides an external bus. Some storage devices 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage devices 128 may also be used as an installation device 116, and may be suitable for installing software and programs. Additionally, the operating system and the software can be run from a bootable medium, for example, a bootable CD, e.g., KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon. com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In some embodiments, the computing device 100 communicates with other computing devices 100′ via any type and/or form of gateway or tunneling protocol e.g., Secure Socket Layer (SSL) or Transport Layer Security (TLS), or the Citrix Gateway Protocol manufactured by Citrix Systems, Inc. of Ft. Lauderdale, Florida. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Washington; MAC OS and iOS, manufactured by Apple, Inc. of Cupertino, California; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, California, among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 can include one or more of a server, a desktop computer, a laptop computer, a mobile device (e.g., a smartphone, tablet, etc.), a network appliance, and/or the like.

In some embodiments, the computing device 100 is a digital audio player such as the Apple IPOD, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g., the IPAD line of devices by Apple; GALAXY TAB family of devices by Samsung; or KINDLE FIRE, by Amazon. com, Inc. of Seattle, Washington. In other embodiments, the computing device 100 is an eBook reader, e.g., the KINDLE family of devices by Amazon. com, or NOOK family of devices by Barnes & Noble, Inc. of New York City, New York.

In some embodiments, the communications device 102 includes a combination of devices, e.g., a smartphone combined with a digital audio player or portable media player. For example, one of these embodiments is a smartphone, e.g., the IPHONE family of smartphones manufactured by Apple, Inc.; a Samsung GALAXY family of smartphones manufactured by Samsung, Inc.; or a Motorola DROID family of smartphones. In yet another embodiment, the communications device 102 is a laptop or desktop computer equipped with a web browser and a microphone and speaker system, e.g., a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In some of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Determining Anomalies Using Machine Learning Models

Systems and methods of the present solution are directed to the configuration and implementation of systems to determine anomalies using machine learning models.

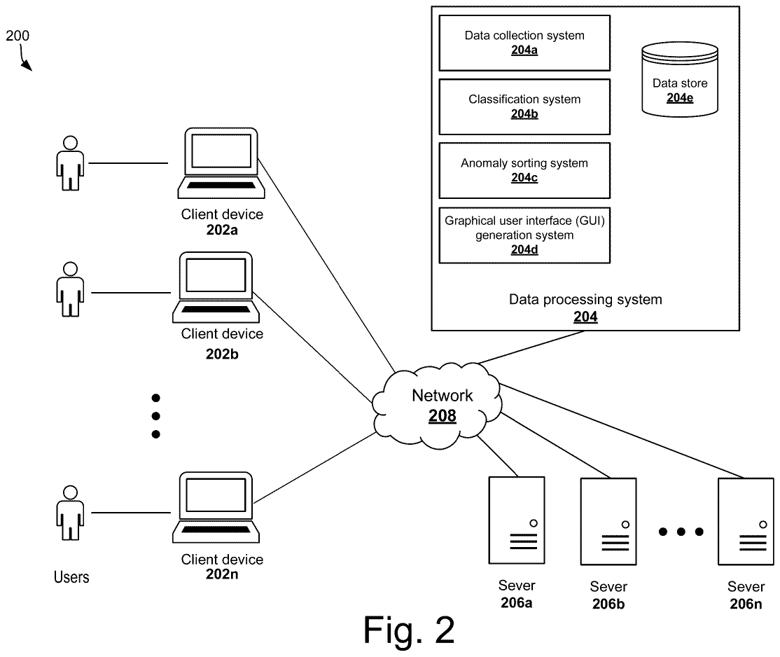

Referring now to FIG. 2, FIG. 2 is a diagram of an example environment 200 in which devices, systems, methods, and/or products described herein can be implemented. As shown in FIG. 2, the environment 200 includes client devices 202a-202n (referred to individually as client device 202 and collectively as client devices 102, where contextually appropriate), a data processing system 204, and servers 206a-206n (referred to individually as server 206 and collectively as servers 206, where contextually appropriate). In some embodiments, the client devices 202, the data processing system 204, and the servers 206 can be configured to interconnect (e.g., establish connections to communicate messages, data, and/or the like, via one or more wired or wireless connections using a network 208 and/or one or more networks that are not explicitly illustrated.

The client devices 202 can include one or more computing devices that are configured to be in communication with the data processing system 204 or the one or more servers 206. For example, the client devices 202 can include a computing device such as individual device (e.g., a laptop computer, a desktop computer, a mobile device such as a tablet or a smartphone). In some examples the client devices 202 can be the same as, or similar to, the clients 102 of FIG. 1A. The client devices 202 can be associated with respective individuals that cause the client devices 202 to at least in part execute one or more operations. These can include network operations that are involved in communication between client devices and servers (e.g., communicating with a server to request data from and/or transmit data to the server using a client device), indirect or direct communication between client devices, etc. These can also include, for example, network operations that are involved in transactions such as financial transactions, electronic funds transfer transactions, payment transactions involving an online transaction, payment transactions involving one or more payment devices and/or point-of-sale devices, mortgage transactions (e.g., initiating, maintaining, or monitoring a mortgage), loan performance (e.g., initiating, maintaining, or monitoring a loan over a payment period involving multiple discrete payments), etc.

The data processing and anomaly detection system 204 (also referred to as data processing system 204) can include one or more computing devices that are configured to be in communication with one or more client devices 202 or the one or more servers 206. For example, the data processing system 204 can include a computing device such as a server, a cloud-based computing device such as a cloud server, or the like. In some examples the data processing system 204 can be the same as, or similar to, the data processing system 120 of FIG. 1C. In examples, the data processing system 204 can be implemented by any of the servers of FIG. 1A or the devices associated with the cloud environment 108 of FIG. 1B. In these examples, one or more devices (or one or more components thereof) described as being capable of implementing the operations performed by the data processing system 204 can implement the operations independent of one another or in coordination with one another. The data processing system 204 can be associated with one or more organizations that are involved in monitoring electronic communications for fraudulent activity. For example, the data processing system can be developed or controlled by a third-party service provider that specializes in fraud detection and offers advanced analytics, machine learning algorithms, and real-time transaction monitoring for sale or as a service to service providers described herein to identify and prevent fraudulent activities across various industries. These services can involve the execution of operations that integrate with existing systems to provide security measures like identity verification, anomaly detection, and risk assessment, helping businesses minimize server downtime and losses due to fraud. In another example, the data processing system can be developed or controlled by a third-party service provider that specializes in cybersecurity threat detection (e.g., to address DDoS attacks, and/or the like). In yet another example, the data processing system can be developed or controlled by a third-party service provider that specializes in identifying performance anomalies (e.g., the identification of sudden or unexplainable increases or decreases in network activity as well as analysis of these increases or decreases to indicate their root cause).

The servers 206 can include one or more computing devices that are configured to be in communication with one or more client devices 202 or the data processing system 204. For example, the servers 206 can include a computing device such as a server, a cloud-based computing device such as a cloud server, or the like that includes one or more data storage components and processors that are configurable to detect and classify network operations that are anomalies in real-time. In some examples the servers 206 can be the same as, or similar to, the servers 106 or one or more components implemented by the cloud environment 108 of FIGS. 1A and 1B. In examples, the servers 206 can implement the data processing system 204 including any or all of the operations that the data processing system 204 is configured to perform. The servers 206 can be associated with one or more transaction service providers that facilitate the electronic handling of payment transactions between buyers (e.g., operating client devices 202) and sellers (e.g., operating different client devices or, in some examples, respective servers 206 involved in processing of credit card, debit card, mortgage, and other forms of electronic payments). In some embodiments, the transaction service providers can handle the entire payment cycle from authorization, batching of transactions, to the final settlement, often incorporating features like multi-currency processing, compliance with payment card industry data security standards (PCI DSS), and real-time transaction reporting. In some embodiments, as the servers 206 execute one or more of the operations described herein, the servers 206 can store information about the executed operations (e.g., quantities of positive anomalies, negative anomalies, noise, etc., classified during execution of one or more operations by the servers 206). The servers 206 can then store the information in a database maintained by the servers 206 and/or in the data store 204e and periodically or continuously generate reports based on the information stored in the database and/or data store 204e. The servers 206 can then generate the GUI data as described herein to additionally, or alternatively, include the information included in the reports and provide the GUI data to one or more of the client devices 202.

The client devices 202, data processing system 204, or the servers 206 can be connected to each other through the network 208, which can be the same as, or similar to, the networks (e.g., the network 104 of FIG. 1A) described herein. Examples of the network 208 can include, but are not limited to, private or public implementations of local-area-networks (LAN), wireless LAN (WLAN) networks, wide-area networks (WANs), and the Internet.

With continued reference to FIG. 2, among others, the data processing system 204 can include any combination of hardware or software that performs one or more of the functions described herein. For example, the data processing system 204 can include any combination of hardware and software configured to perform anomaly detection using machine learning models. In some embodiments, the data processing system 204 can include any computing device (e.g., a computing device that is the same as, or similar to, the computing device 100 of FIG. 1C) and can include one or more servers, virtual machines, or can be part of or include a cloud computing environment.

While certain aspects of the present disclosure are discussed with respect to the processing of network operations involved in transactions such as payment transactions, it will be understood that the techniques described herein can be applied to any suitable field in which anomaly detection is involved. These fields can include cybersecurity, where detecting unusual patterns represented by data included in one or more messages or data included therein can indicate malware or hacking attempts; telecommunications, for spotting irregular usage that could signify fraud or service abuse; healthcare, for identifying false insurance claims or medical identity theft; and even in broader applications like IoT (Internet of Things) systems, where anomalous sensor data might indicate equipment failure or security breaches. Furthermore, these techniques can be valuable in financial markets for detecting market manipulation or insider trading, showcasing the versatile applicability of anomaly detection across various domains where electronic data integrity and security are paramount. For example, where individuals (e.g., borrowers who have balances related to revolving accounts such as credit accounts, mortgages, or the like) are seeking to intentionally default on their obligations (also referred to as a strategic default), the presently-disclosed techniques can be applied to compare the account activity of the individuals seeking to intentionally default with other individuals that have not, and do not take actions that indicate that they intend to default. In this example, account activity for these accounts can be represented as features (e.g., indicating debt to credit ratios, income to debt ratios, points in time at which a default occurs (e.g., after one or more payments are processed or a threshold amount of a loan has been repaid), whether a mortgage value exceeds a corresponding asset value, or the like) that are then processed to determine clusters against which subsequent account activity of accounts for individuals can be compared. In this example, the accounts compared to the clusters can be associated with negative anomalies and a GUI can be generated to indicate that the account is likely to be involved in a strategic default or that it is likely the account is already involved in a strategic default.

The data processing system 204, or components thereof, can include a physical or virtual computer system operatively coupled, or associated with, the servers 206. The data processing system 204, or components thereof, can be coupled, or associated with, the servers 206 using the network 208, either directly or indirectly through an intermediate computing device or system. The network 208 can be any type or form of network. The geographical scope of the network can vary widely and can include a body area network (BAN), a personal area network (PAN), a local-area network (LAN) (e.g., Intranet), a metropolitan area network (MAN), a wide area network (WAN), or the Internet. The network 208 can use different techniques and layers or stacks of protocols, including, for example, the Ethernet protocol, the internet protocol suite (TCP/IP), the ATM (Asynchronous Transfer Mode) technique, the SONET (Synchronous Optical Networking) protocol, the SDH (Synchronous Digital Hierarchy) protocol, etc. The TCP/IP internet protocol suite can include application layer, transport layer, internet layer (including, e.g., IPv6), or the link layer. The network 208 can be a type of a broadcast network, a telecommunications network, a data communication network, a computer network, a Bluetooth network, or other types of wired and wireless networks.

The data processing system 204 can include one or more of a data collection system 204a, a classification system 204b, an anomaly sorting system 204c, a graphical user interface (GUI) generation system 204d, or a data store 204e. While each of the systems of the data processing system 204 are described as being configured to perform one or more operations, the components can cooperate with one or more different components of the data processing system 204 to perform the one or more operations described herein. The data processing system 204 can be interconnected with one or more other data processing systems (not explicitly illustrated) that operate in cooperation with the each other (e.g., independently or when implemented by one or more servers 206) to perform one or more of the operations described herein.

The data collection system 204a can be implemented by the data processing system 204 or can be a device that is the same as, or similar to, the computing device 100 of FIG. 1C. In some embodiments, the data collection system 204a can receive network operation data associated with (e.g., representing) a plurality of network operations processed by a communication network (e.g., the network 208). For example, the data collection system 204a can receive network operation data associated with (e.g., representing) a plurality of network operations involved in processing one or more transactions. The one or more transactions can be represented by one or more features including original features such as, for example, a category of purchase (e.g., home repair, grocery, etc.), an amount of a given currency involved in the transactions, a state in which the transactions are initiated or completed by one or more individuals or organizations, a city population (e.g., of the individual or organization involved in the network operation), a customer location (e.g., represented as latitude and longitude coordinates), a merchant location (e.g., represented as latitude and longitude coordinates) or the like. In some embodiments, the one or more transactions can be represented one or more features including one or more engineered features such as, for example, a category of purchase (represented as a numeric value), a time stamp representing the month/week/day/hour at which the purchase was initiated or in part executed, a state involved in the purchase (represented as a numeric value), a distance between an address associated with a customer's payment device and an address associated with a merchant involved in a transaction, or the like. In some embodiments, the one or more transactions can be represented one or more features including one or more synthetic features (or variables) (e.g., values that are artificially created and do not exist in the original data but are generated using domain knowledge or statistical analysis). such as, for example, a rate at which a customer's credit card is utilized, a maximum charge to the credit card for a period of time (e.g., a previous month), a number of days since the credit card user last changed their email, a distance (e.g., in miles) between the zip code associated with the customer's credit card and the zip code associated with the point of purchase, or the like. The one or more transactions can be represented by one or more engineered features (e.g., values that have been derived or transformed from the original features to make them more useful for machine learning models), and/or more original features (e.g., raw, unmodified attributes collected directly from the data source. They represent the data in its natural form, as it is received by the system). In some embodiments, the one or more transactions can be represented one or more features including one or more additional or synthetic features such as indicators that identify whether the transactions are online orders, whether the retailer is a new retailer or an established retailer (e.g., has been in business for at least a predetermined period of time), a percent of transactions that occurred out of customer state, whether the customer has an existing social media profile, whether the customer is a homeowner, a percent change in customer's credit score after a purchase, a period associated with the credit history of a customer (e.g., a credit age at the time of purchase between 0 and 30 in years), whether a social security number (SSN) of a customer involved in a transaction matches with the name and date of birth of the customer, or the like.

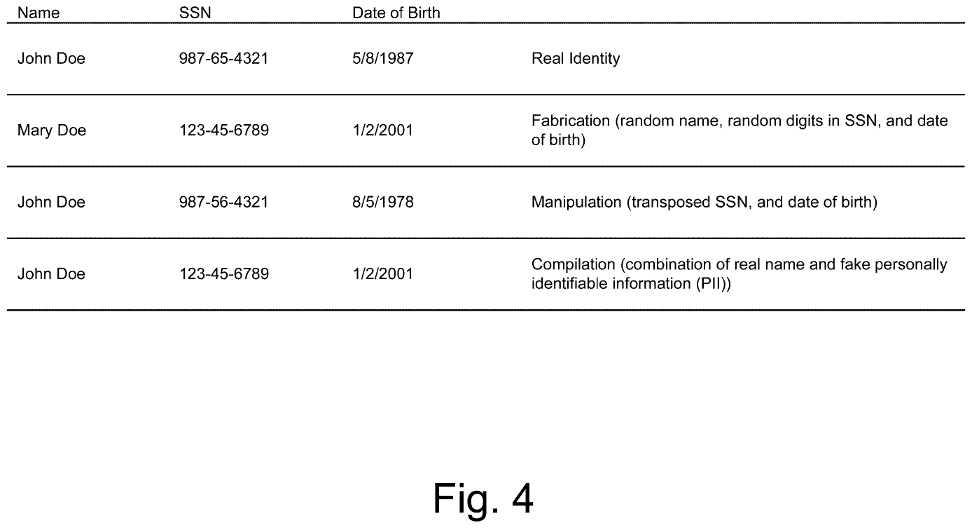

In some embodiments, the data collection system 204a can receive network operation data associated with a plurality of network operations processed by the network 108, where one or more network operations are involved in fraudulent activity. For example, the data collection system 204a can receive network operation data associated with at least one network operation representing a transaction that is initiated by an individual (referred to as a malicious individual) or group of individuals through manipulation of data that is compromised for a particular individual (e.g., customer). In one example, where an individual named “John Doe” has their identity compromised by a malicious individual, the malicious individual may engage a client device 202 to cause one or more synthetic fraud transactions to be performed. In this example, the malicious individual can obtain information identifying John Doe, such as John's social security number “987-65-4321” or date of birth “May 8, 1987 or May 8, 1987, or Jan. 2, 2001.” The malicious individual can then initiate the one or more synthetic fraud transactions (e.g., payment transactions, account generations, or the like) by manipulating subsets of the information identifying John Doe or fabricating entire network operations. Manipulation can include incorporating typos into the synthetic fraud transactions such as by updating or reversing John Doe's name (e.g., “John Eric Doe” or “Mary Doe”), updating or reversing portions of Jane's SSN (e.g., “987-56-4321”, or updating multiple portions of the combination of information identifying Jane (e.g., Name: “John Eric Doe,” SSN: “987-56-4321,” date of birth “Jan. 2, 2001”) in one or more of the fields in which the information would be input. By initiating the one or more synthetic fraud transactions, the malicious individuals can cause one or more transactions to be implemented, consuming both computing resources (e.g., for online sales) and physical resources (e.g., when causing merchants to provide goods or services. Examples of manipulations are represented in FIG. 4.

In some embodiments, the data collection and preprocessing system 204a (also referred to as the data collection system 204a) can be configured to execute a set of preprocessing operations. For example, to train an isolation forest model or cluster the network operations based on scores obtained using the isolation forest model, the data collection system 204a can be configured to execute one or more data sampling operations such as selection of a representative subset of network operations from a larger dataset of network operations to ensure efficient model training and accurate performance evaluation. This sampling can be implemented to avoid imbalances in training datasets used to train the isolation forest model, where certain classes or events (e.g., positive anomalies, negative anomalies, or noise) can be underrepresented. Techniques such as stratified sampling can be employed to maintain the original data distribution to increase the probability that each class is sampled in proportion to its presence in the network operation data. This preprocessing can both reduce computational demands and enhance the isolation forest model's ability to generalize from the training data to unseen data (e.g., unseen network operations), thereby improving the reliability and efficiency of the scoring of the unseen network operations based on the isolation forest model.

In some embodiments, the data collection system 204a can be configured to receive and preprocess network operations that include numerical data (e.g., values that can be scaled, normalized, or used as-is depending on the configuration of the data classification system 204b), categorical data that can be transformed through one-hot encoding, label encoding, or similar techniques to convert categories into a format that machine learning models implemented by the data classification system 204b can process), timestamp data that can split a set of related network operations (e.g., multiple, related purchases, payments, etc.) into multiple engineered features (e.g., day of the week, hour of the day) to capture time-based patterns in the data, and/or text data represented by the network operations that can be vectorized using techniques like TF-IDF or word embeddings to create features from textual inputs).

In some embodiments, the data collection system 204a can be configured to execute one or more data imputation operations. For example, in the context of synthetic fraud detection, the data collection system 204a can be configured to update (e.g., add) missing values to one or more network operations representing a percentage change in the credit score over a particular period of time and can arise from various issues like system errors, incomplete user entries, or data transmission errors. These imputation techniques can address gaps in the network operation data by estimating and filling in missing data, thereby preserving the integrity of the training dataset. Techniques range from statistical methods like mean or median imputation for numerical data to approaches like using machine learning algorithms (e.g., K-Nearest Neighbors or regression models) that predict missing values based on other features of the network operations being preprocessed. By implementing the data imputation operations described, the data collection system 204a can be configured to both maintaining the training dataset size but also ensure that the patterns and relationships of the plurality of network operations represented by the network operation data are not lost due to data incompleteness. This can, in turn, improve a trained isolation forest's ability to generalize from the training data, reducing bias and improving the detection of anomalies indicative of positive anomalies, negative anomalies, or noise.

In some embodiments, the data collection system 204a can be configured to update at least a portion of the network operation data in response to the data collection system 204a executing the set of preprocessing operations. For example, the data collection system 204a can be configured to update the representation of the one or more network operations such that the network operations are normalized while maintaining aspects that can be indicative of anomalies. This can include, for example, the data collection system 204a determining one or more updates to one or more of the network operations of the plurality of network operations. In some embodiments, the data collection system 204a can update (e.g., add) missing entries used to represent the network operations that can be inferred from the remaining entries of the network operations while forgoing updates that can be indicative of anomalies (e.g., transposing digits used to represent an individual's SSN that were possibly transposed by a malicious individual when generating a synthetic fraud transaction).

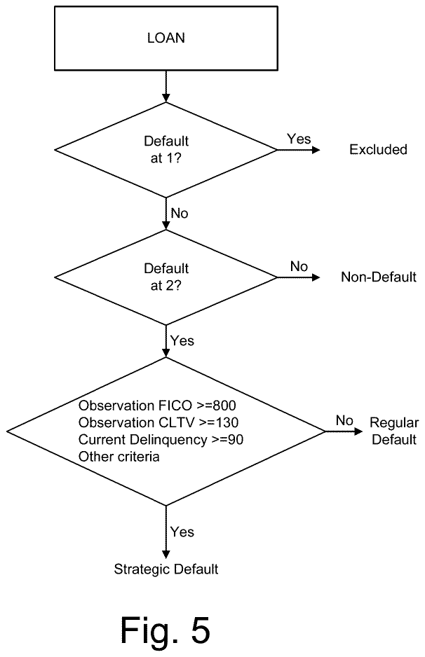

In some embodiments, to allow for training of one or more components of the data processing system 204, the data collection system 204a can receive or annotate the network operation data where at least a portion of the network operations are tagged as being associated with one or more types of anomalies. For example, in the context of network operations that represent activity of mortgage accounts, the data collection system 204a can receive or annotate network operations as being associated with negative anomalies when it is determined that the corresponding defaults are indicative of strategic defaults. This can include implementing a model to analyze each respective network operation to determine whether there was a default in the first month (e.g., month 1), the second month (e.g., month 2) or after the third month. In the case of defaults in the first month and second month, the corresponding network operations can be identified as excluded or not defaults (e.g., in the case where there was an error in initializing accounts involved in automatic payment that led to inadvertent default). In the case of defaults after the third month, features of the network operations where there is a default can be evaluated to determine whether the default is a regular default or a strategic default. In the case of a regular default, where the individual paying the mortgage has a FICO score less than a threshold value (e.g., 800), a customer lifetime value (CLT) of less than a threshold value, a delinquency period associated with one or more accounts of the individual, or the like. Where one or more of these criteria are satisfied, the network operations can be tagged as negative anomalies (e.g., strategic defaults). Where one or more of these criteria are not satisfied, the network operations may not be tagged as negative anomalies. An example of evaluation criteria for evaluating network operations involving mortgages for strategic defaults is illustrated in FIG. 5. As will be understood, the data processing system 204 can then use this annotated network operation data when training and/or testing one or more of the models implemented by the system(s) of the data processing system 204.

In some embodiments, the data collection system 204a can store at least a portion of the network operation data in the data store 204e as a dataset (e.g., a training dataset or the like). For example, the data collection system 204a can store the network operation data as a training dataset to allow one or more components of the data processing system 204 to train or implement an isolation forest and subsequently perform a cluster analysis to cluster the network operations. In some embodiments, the data collection system 204a can store the network operation data at a single point in time (e.g., when processing a batch of network operations), at one or more periodic points in time (e.g., when processing individual network operations or batches of network operations), or continuously (e.g., in response to receiving each network operation to be analyzed). In some embodiments, by periodically or continuously storing the network operation data in the data store 204e, the data collection system 204a can allow one or more other components of the data processing system 204 to iteratively perform the operations described herein and allow for iterative refinement of isolation forests and cluster analysis used to classify network operations as either positive anomalies, negative anomalies, or noise.

In some embodiments, the classification system 204b can be implemented by the data processing system 204 or can be a device that is the same as, or similar to, the computing device 100 of FIG. 1C. The classification system 204b can be configured to implement a machine learning model when analyzing network operation data. For example, the classification system 204b can be configured to implement a machine learning model that receives, as an input, the network operation data associated with one or more network operations and generates, as an output, scores for each network operation. The scores can represent the relative position of each network operation within an anomaly score domain (also referred to as a score range) in which similarities between each network operation of the plurality of network operations can be represented using scores (also referred to as anomaly scores).

In an example, the classification system 204b can be configured to provide network operation data to an isolation forest model to cause the isolation forest model to generate an anomaly score for each network operation. For example, the classification system 204b can provide the network operation data to an isolation forest model that is trained to generate scores for network operations that represent transactions. In this example, each transaction can be represented using one or more entries, where the values included in each entry identify one or more aspects of the transaction. In some embodiments, the scores output by the isolation forest model can indicate a value within a range of values (e.g., from 0-1). In examples, where scores are closer to one portion of the range of values (e.g., from 0-0.5) indicate that a given transaction is similar to a majority of other transactions (e.g., does not represent an anomalous transaction). As will be appreciated, scores that approach an end of the range (e.g., approach 0) can indicate with increasing confidence that corresponding transactions do not represent anomalous transactions. In examples, where scores are farther from the portion of the range of values (e.g., from 0.5-1) can indicate that a given transaction is not similar to a majority of other transactions. As will be appreciated, scores that approach an end of the range (e.g., approach 1) can indicate with increasing confidence that corresponding transactions do represent anomalous transactions.

In some embodiments, the classification system 204b can determine that one or more network operations form a subset of network operations that satisfy an anomaly score threshold. For example, the classification system 204b can determine that the one or more network operations of the subset of network operations are associated with a score that satisfies a value represented by the anomaly score threshold. In this example, the anomaly score threshold can indicate whether the corresponding transactions are anomalous or not anomalous. In one example, the subset of transactions that are indicated as being anomalous can represent one or more of positive anomalies, negative anomalies, or noise that each individually satisfy the anomaly score threshold, as described herein. In some embodiments, the classification system 204b can then determine the subset of network operations in response to the classification system 204b determining that each network operation of the subset of network operations satisfies the anomaly score threshold.

In some embodiments, the data processing system 204 can determine one or more attributes associated with one or more clusters of network operations. For example, the data processing system 204 can determine the one or more attributes based on the features of one or more network operations. In this example, the data processing system 204 can implement (e.g., construct) an isolation forest by randomly selecting a subset of the network operations included in the training dataset stored in the data store 204e. This subsampling can allow for a reduction in computational complexity by ensuring an even distribution across all of the types of network operations involved included in the training data set. For each tree in the isolation forest, a feature can be randomly selected from the training dataset to avoid overfitting to the training data's structure. The data processing system 204 can then select (e.g., randomly) a split value within the selected feature's range to partition the training dataset into two subsets. In some embodiments, the data processing system 204 can recursively select split values and further partition segments of the training dataset until a given subset contains only one instance or the given tree reaches a pre-specified height limit. In some embodiments, the data processing system 204 can then calculate anomaly scores as described herein based on an average path length involved in isolating a given network operation across all trees in the isolation forest.

In some embodiments, the data processing system 204 can determine a feature importance (e.g., a global feature importance (GFI) or a local feature importance (LFI)) using the isolation forest. For example, in the context of a GFI, the data processing system 204 can determine a degree to which a feature is influential in determining whether a set of network operations are associated with an anomaly when applied across the entire training dataset. This degree can be referred to as a global importance score. To determine this degree to which a feature is influential across the entire training dataset, the data processing system 204 can calculate an average depth at which splits involving that feature occur across all trees. Features that lead to splits closer to the root (shallower depths) can be considered more important (e.g., have higher importance scores) because they are more effective at isolating anomalies quickly in comparison to features that lead to splits farther from the root (deeper depths). The data processing system 204 can then aggregate the importance scores for each feature across all trees to provide a global importance score that corresponds to each feature.

In the context of an LFI, the data processing system 204 can determine a degree to which a feature is influential in determining whether a specific network operation or subset of network operations is associated with an anomaly as described herein. For example, the data processing system 204 can determine which features were used to form a split at each node along a path of a given network operation or set of network operations. For each feature involved in the path of the network operation or set of network operations, the data processing system 204 can determine the degree to which each split contributed to the isolation of that instance. Features that appear earlier in the path (closer to the root) when analyzing a given network operation or set of network operations using the isolation forest can be identified as contributing more to the isolation of the given network operation(s). The data processing system 204 can then determine a score for each feature based on respective contributions to the isolation of the given network operation(s). This could be a function of how early the feature was used and how many times it appeared in the path across all trees to determine whether the network operation was an anomaly.

In some embodiments, the data processing system 204 can determine a decision function based on the GFI or LFI of one or more network operations. For example, the data processing system 204 can determine the decision function based on the relative importance of one or more GFIs or one or more LFIs derived from analysis of the network operations using the isolation forest. In this example, the function can be used to then arrive at a score for each network operation that can be used to cluster the network operations into positive anomalies, negative anomalies, or noise, as described herein.

In some embodiments, the data processing system 204 can cluster the network operations in the training dataset based on an GFI or LFI of each network operation. For example, the data processing system 204 can first determine GFI scores for each network operation of the training dataset and select the network operations that are identified as anomalous based on the data processing system 204 determining their GFI score (e.g., where each selected network operation has a GFI score that satisfies a threshold GFI score associated with anomalies). The data processing system 204 can then cluster the selected network operations using algorithms such as K-means or DBSCAN. The data processing system 204 can then determine LFI scores for each of the selected network operations to dynamically weight features within clusters based on their relevance to specific subsets of network operations. This hybrid approach can both capture general patterns (though GFI scores) and nuances in the network operations (through LFI scores), resulting in clusters that represent different types of anomalies such as positive anomalies, negative anomalies, or noise. The process can be iteratively refined by evaluating cluster quality and adjusting feature importance weights, such that the clusters are further associated with positive anomalies, negative anomalies, or noise. For purposes of clarity, these clusters that are iteratively refined are sometimes referred to as refined clusters.

In some embodiments, the anomaly sorting system 204c can be implemented by the data processing system 204 or can be a device that is the same as, or similar to, the computing device 100 of FIG. 1C. The anomaly sorting system 204c can be configured to determine, for each network operation of the subset of network operations, that the anomaly is a positive anomaly, a negative anomaly, or noise. For example, the anomaly sorting system 204c can be configured to determine whether each network operation of the subset of network operations that satisfies the anomaly score threshold is a positive anomaly, a negative anomaly, or noise. As described herein, the anomaly sorting system 204c can be configured to determine the type of each anomaly for each network operation based on the score corresponding to each network operation.

In some embodiments, the anomaly sorting system 204c can determine whether network operations from among the subset of network operations identified as including anomalies are associated with positive anomalies. For example, the anomaly sorting system 204c can determine whether network operations of the subset of network operations are positive anomalies based on whether the network operations have scores that correspond to (e.g., satisfy the criteria of) one or more clusters of network operations. In this example, the one or more clusters can include refined clusters that are predetermined to represent sets of network operations that are associated with positive anomalies. The network operations identified as associated with the positive anomalies can be associated with transactions that are not fraudulent but are represented by values for one or more entries that are not typical (e.g., not similar) to other transactions. In some examples, a positive anomaly can occur if a customer who typically makes small, local purchases suddenly makes a large purchase while traveling abroad In one example, transactions can be considered positive anomalies where the transactions are not similar to other transactions involving a specific individual. This can be the case where the individual initiates a transaction that is for a value that exceeds a threshold value (e.g., is considered a large purchase for that individual), is outside of a geographic area associated with the individual (e.g., is outside a county or state in which the individual lives or works), or the like. In response to the anomaly sorting system 204c determining that network operations from among the subset of network operations identified as including positive anomalies, the data processing system 204 can cause the GUI generation system 204d to generate a GUI including a warning message. Alternatively, in response to the anomaly sorting system 204c determining that network operations from among the subset of network operations identified as including positive anomalies, the data processing system 204 can determine that the corresponding transactions are not fraudulent and forgo causing the GUI generation system 204d to generate the GUI including the warning message. As described herein, positive anomalies, being benign deviations, may not require immediate action, whereas negative anomalies, associated with potential harmful activities, can trigger a GUI warning to alert users, etc. to possible threats. Similarly, noise can also represent benign deviations that may not require immediate action.

In some embodiments, the anomaly sorting system 204c can determine whether network operations from among the subset of network operations identified as including anomalies are associated with negative anomalies. For example, the anomaly sorting system 204c can determine whether network operations of the subset of network operations are negative anomalies based on whether the network operations have scores that correspond to (e.g., satisfy the criteria of) one or more clusters of network operations. In this example, the anomaly sorting system 204c can determine that the scores correspond to the one or more refined clusters of network operations that are predetermined as including negative anomalies. The network operations associated with the negative anomalies can be associated with transactions that are fraudulent and represented by values for one or more entries that can be typical (e.g., similar) to other transactions that are not fraudulent. In one example, transactions can be fraudulent and associated with negative anomalies where the transactions involve a particular individual that are similar to other transactions involving that individual. This can be the case where the transaction is initiated by a malicious individual but, apart from certain aspects of the transaction, would otherwise be considered a non-anomalous transaction (e.g., the transaction may not exceed a threshold value, may be initiated within a geographic area associated with the individual (e.g., is within a county or state in which the individual lives or works), or the like). In the case of transactions representing negative anomalies where a malicious individual is generating the transaction in accordance with one or more synthetic fraud techniques, the transaction can have one or more entries intentionally updated such that typographical errors are introduced (e.g., a portion of a name of a customer is missing, two or more numbers in an identifier such as a SSN or date of birth are transposed, or combinations thereof). In response to the anomaly sorting system 204c determining that network operations from among the subset of network operations identified as including negative anomalies, the data processing system 204 can cause the GUI generation system 204d to generate a GUI including a warning message.

In some embodiments, the anomaly sorting system 204c can determine whether network operations from among the subset of network operations identified as including anomalies are associated with noise anomalies (generally referred to as “noise”). For example, the anomaly sorting system 204c can determine whether network operations of the subset of network operations are noise based on whether the network operations have scores that do not correspond to any clusters of network operations (e.g., satisfy a distance threshold associated with a given cluster of network operations). The network operations associated with noise can be associated with transactions that are not fraudulent but represented by values for one or more entries that are not typical (e.g., not similar) to other transactions that are not fraudulent. In one example, transactions can be considered noise they involve a particular individual, are similar to other transactions involving that individual, and include typographical errors. This can be the case where the transaction is initiated by an individual and correctly identifies that individual, but that individual mistakenly provides information in error. In the case of transactions representing noise where an individual, the transaction can have one or more entries where typographical errors are introduced (e.g., a customer misspells their own name, double-clicks a number by accident when inputting their zip code, or the like). In some instances, the individual can then be prompted to re-enter the information, and can correctly do so. In examples, the anomaly sorting system 204c can determine that the corresponding network operation is noise, and the data processing system 204 can cause the GUI generation system 204d to generate a GUI including a warning message. In other examples, the anomaly sorting system 204c can determine that the corresponding network operation is noise, and the data processing system 204 can forgo causing the GUI generation system 204d to generate a GUI including a warning message.

In some embodiments, the GUI generation system 204d can generate a GUI to indicate that one or more network operations were executed that are identified as positive anomalies, negative anomalies, or noise. For example, the GUI generation system 204d can generate a warning in response to determining that one or more anomalies correspond to positive anomalies or noise. In this example, the warning message can be generated to allow one or more systems and/or individuals to review potentially non-fraudulent transactions where one or more aspects are outside an established norm across a plurality of network operations, either with respect to certain clusters of network operations as described herein (positive anomalies) or with respect to a plurality of network operations (noise). In comparison, the GUI generation system 204d can generate warning in response to determining that one or more anomalies correspond to negative anomalies, whereas a warning for negative anomalies would likely prompt immediate investigation or intervention and/or indicate that immediate intervention occurred and provide an opportunity to permit or not permit the network operation from being executed.

In some embodiments, the GUI generation system 204d can be implemented by the data processing system 204 or can be a device that is the same as, or similar to, the computing device 100 of FIG. 1C. The GUI generation system 204d can be configured to generate one or more GUIs based on one or more of the components of the data processing system 204 indicating that a network operation or a set of network operations are indicative of positive anomalies, negative anomalies, or noise. In some embodiments, the GUI generation system 204d can generate a GUI that includes a warning message in response to one or more components of the data processing system 204 determining that a given network operation is associated with a positive anomaly. For example, the GUI generation system 204d can generate a GUI that includes a warning message in response to one or more components of the data processing system 204 determining that the given network operation is associated with a transaction involving an individual that is atypical when compared to other transactions involving the individual. This can include transactions for large purchases but are not fraudulent.

In some embodiments, the GUI generation system 204d can generate a GUI that includes a warning message in response to one or more components of the data processing system 204 determining that a given network operation is associated with a negative anomaly. For example, the GUI generation system 204d can generate a GUI that includes a warning message in response to one or more components of the data processing system 204 determining that the given network operation is associated with a transaction that purportedly involves an individual but that is atypical when compared to other transactions involving the individual. This can include transactions where a malicious individual has engineered the transaction in accordance with one or more synthetic fraud techniques (e.g., transposing portions of identifiers associated with the individual or the like).

In some embodiments, the GUI generation system 204d can generate a GUI that includes a warning message in response to one or more components of the data processing system 204 determining that a given network operation is associated with noise. For example, the GUI generation system 204d can generate a GUI that includes a warning message in response to one or more components of the data processing system 204 determining that the given network operation is associated with a transaction involving an individual that is atypical but not fraudulent. In one example, where an individual introduces a typographical error (e.g., misspells their name, incorrectly enters an identifier such as a zip code, or the like), the GUI generation system 204d can receive an indication from one or more components of the data processing system 204 that the transaction is noise, the GUI generation system 204d can generate the GUI such that the GUI includes an indication that the transaction is not fraudulent, but includes the noise.

In some embodiments, the GUI generation system 204d can provide GUI data associated with the GUI(s) described herein to cause one or more devices to display the GUI. For example, where a client device 202 is indirectly interconnected to a server 206 to allow for monitoring of network operations involving that server 206, the GUI generation system 204d can provide the GUI data to the client device 202 in response to the GUI generation system 204d generating the GUI. This can be as a result of the server 206 processing the network operation that caused the GUI generation system 204d to generate the GUI. In some embodiments, the client device can then receive input from a user indicating that one or more network operation should be suspended, or that one or more remedial actions should be taken. For example, the user can provide input to the server 206 using the client device 202, where the input indicates that a network operation associated with a given transaction should be suspended or reversed. In another example, the user can provide input to the server 206 to cause network traffic associated with one or more network operations to be suspended for a period of time.

The number and arrangement of systems and/or devices shown m FIG. 2 are an example and one of ordinary skill will understand that there can be additional, fewer, or different systems and/or devices. The systems shown in FIG. 1A-1C can be implemented using a single system or as a combination of systems. Additionally, a set of systems of environment 100 can be configured to perform one or more operations that are described by the present disclosure as being performed by another set of systems of the environment 200.

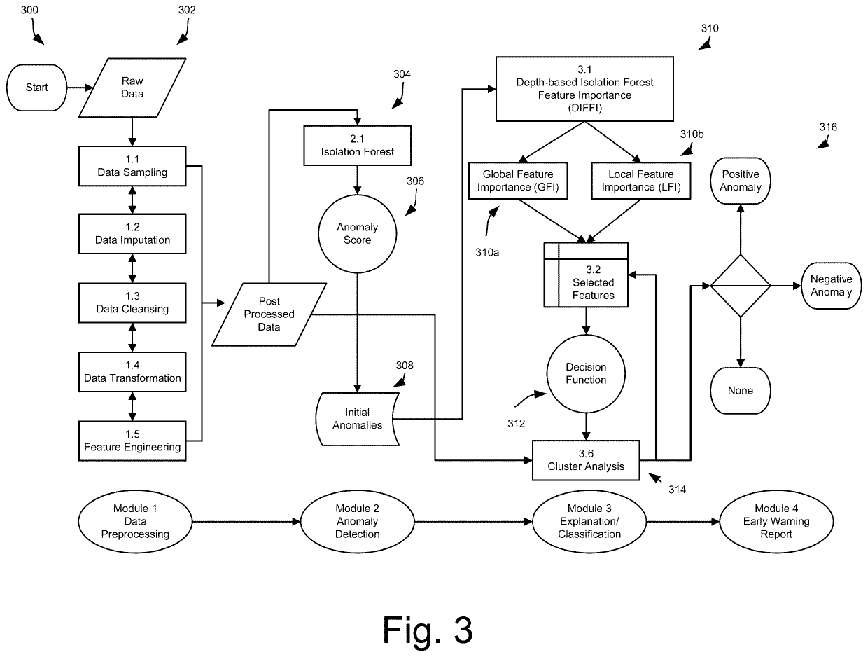

Referring now to FIG. 3, FIG. 3 is an example flow diagram of a process 300 for analyzing and classifying network operations, in accordance with some embodiments. In some embodiments, one or more of the operations described with respect to the process 300 can be performed (e.g., completely, partially, or the like) by a data processing system that is the same as, or similar to, the data processing system 204 of FIG. 2. In some embodiments, one or more of the operations described with respect to the process 300 can be performed by another device or a group of devices separate from or including the data processing system. For example, one or more of the operations of the process 300 can be performed by a server that is the same as, or similar to, the server 206 of FIG. 2. In this example, the server can implement the data processing system as described herein.

At operation 302, the data processing system can pre-process network operation data associated with one or more network operations. For example, the data processing system can pre-process network operation data associated with one or more network operations that represent transactions between two or more parties. In this example, the data processing system can sample the network operations to optimize a distribution of a resulting training dataset, perform data imputation operations to update (e.g., repair) the representation of the network operations, clean the network operations (e.g., by removing irrelevant fields or the like), or the like. The transactions can include individual (e.g., discrete) transactions such as payment transactions involving a point-of-sale device at a store, transactions involving multiple sub-transactions (e.g., mortgages where payment is performed at a plurality of points in time), or the like. The data processing system can then store the pre-processed network operation data in a data store that is the same as, or similar to, the data store 204e of FIG. 2.

At operation 304, the data processing system can provide the pre-processed network operation data to an isolation forest model to train an isolation forest represented by the isolation forest model. For example, the data processing system can provide the pre-processed network operation data to an isolation forest to construct one or more trees in the isolation forest based on sampled subsets of the network operations represented by the network operation data. For each tree, a feature can be randomly selected, and then a split value within a range for that feature can also be randomly selected, partitioning the network operation data into two subsets. This process can be repeated recursively on each subset until either the data points are isolated or a predetermined tree depth is reached. The constructed trees can then forms the isolation forest, which collectively determines an anomaly score based on the average path length for isolating each data point across all trees.

At operation 306, the data processing system can determine anomaly scores for one or more network operations. For example, the data processing system can provide the one or more network operations from the training dataset or network operations received after construction of the trees in the isolation forest to determine anomaly scores for each network operation. The data processing system can then separate the network operations with anomaly scores that satisfy an anomaly score threshold in an anomaly dataset 308 from the network operations that do not satisfy the anomaly score threshold.

At operation 310, the data processing system can determine feature importance for the features used to represent the network operations. For example, at operation 310a, the data processing system can determine a global feature importance indicating a hierarchy of features represented across all the network operations that are indicative of an anomaly. In this example, at operation 310b, the data processing system can determine a local feature importance indicating a hierarchy of features for individual network operations or sets of network operations that are indicative of an anomaly. At operation 312, the data processing system can then determine a decision function based on the global feature importance (e.g., the features that are identified as important in determining anomalies when compared to other features across the set of network operations) or the local feature importance (e.g., the features that are identified as important in determining anomalies when compared to other features for a given network operation or subset of network operations).

At operation 314, the data processing system can cluster the network operations processed and scored by the data processing system using the isolation forest. For example, the data processing system can cluster the network operations into one or more clusters and, in some instances, corresponding sub-clusters. In this example, the data processing system can cluster the network operations and perform a cluster analysis to determine aspects about each cluster. For example, the data processing system can determine that one or more network operations assigned to a particular cluster are known to include negative anomalies (e.g., instances of synthetic fraud) and the data processing system can determine that that particular cluster is associated with negative anomalies. The data processing system can likewise determine that network operations are associated with positive anomalies or noise based on the network operations assigned to those clusters.

At operation 316, after the clusters are determined as being associated with positive anomalies, negative anomalies, or noise, the data processing system can determine that network operations (included in the training dataset or subsequently-received network operations) that have a score indicating they are anomalous are further indicative of positive anomalies, negative anomalies, or noise. The data processing system can then cause one or more GUIs to be generated (e.g., at a display associated with the data processing system or at a client device in communication with the data processing system). The GUIs can include warning messages identifying network operations or sets of network operations as being positive anomalies, negative anomalies, or noise.

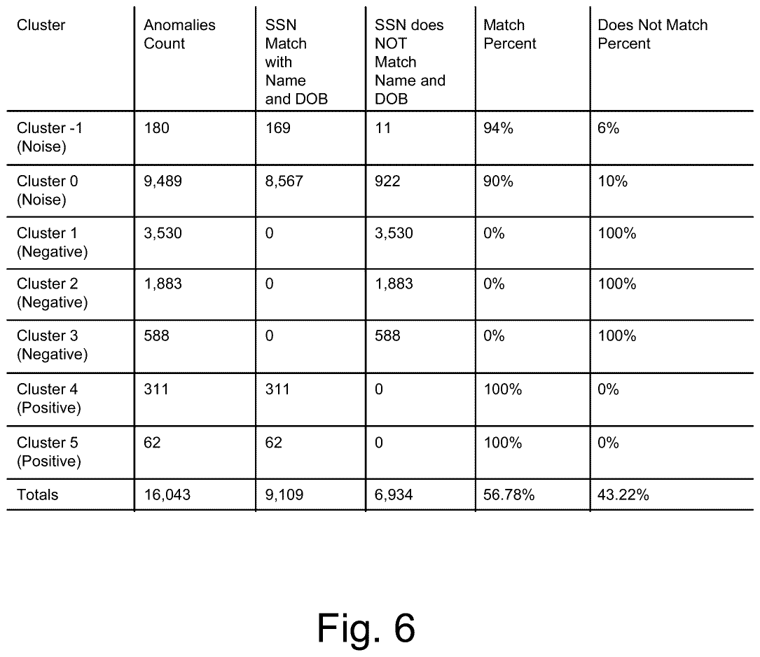

FIG. 6 is an example distribution of clusters of network operations that can be involved in synthetic fraud, in accordance with some embodiments. As illustrated in FIG. 6, and with reference to operations performed by the data processing system 204 of FIG. 2, one or more clusters can be formed among a plurality of network operations representing transactions. For example, each transactions of a plurality of transactions can be represented using features such as a total number of anomalies for a given cluster (e.g., an anomaly count), an indication of a number of anomalies in the cluster that indicate a SSN that matches the SSN of the individual purportedly involved in a given transactions, an indication of a number of anomalies in the cluster that indicate a SSN that does not match the SSN of the individual purportedly involved in a given transactions, a percent of anomalies where the SSNs match, and a percent of anomalies where the SSNs do not match. In this example, two clusters (“Cluster-1” and “Cluster 0”) can be identified as noise, three clusters (“Cluster 1,” “Cluster 2,” and “Cluster 3”) can be identified as including negative anomalies, and two clusters (“Cluster 4” and “Cluster 5”) can be identified as including positive anomalies.

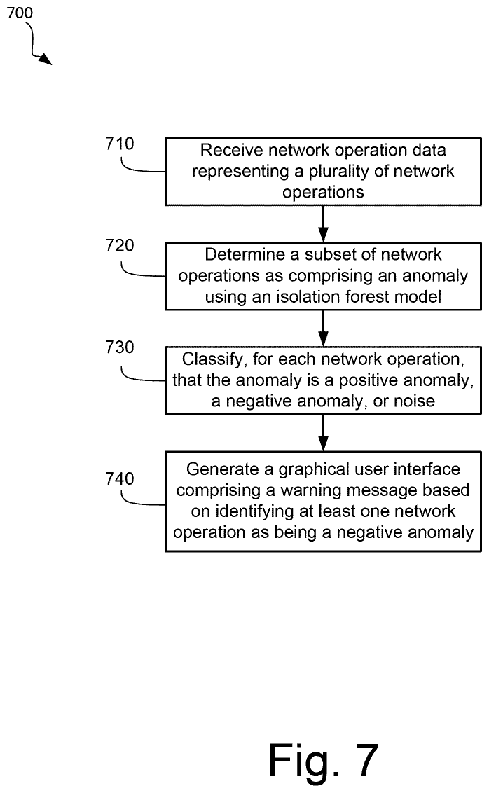

FIG. 7 is a is a flow diagram of a method 700 for analyzing and classifying network operations, in accordance with some embodiments. In some embodiments, one or more of the operations described with respect to the method 700 can be performed (e.g., completely, partially, or the like) by a data processing system that is the same as, or similar to, the data processing system 204 of FIG. 2. In some embodiments, one or more of the operations described with respect to the method 700 can be performed by another device or a group of devices separate from or including the data processing system. For example, one or more of the operations of the method 700 can be performed by a server that is the same as, or similar to, the server 206 of FIG. 2. In this example, the server can implement the data processing system as described herein. In some embodiments, one or more of the operations described with respect to the method 700 can be the same as, or similar to, the operations described with respect to the process 300 of FIG. 3.

At operation 710, the data processing system can receive network operation data representing a plurality of network operations. The data processing system can then pre-process the network operation data associated with one or more network operations. For example, the data processing system can pre-process network operation data to optimize a distribution of a resulting training dataset, perform data imputation operations to update (e.g., repair) the representation of the network operations, clean the network operations (e.g., by removing irrelevant fields or the like), or the like. The data processing system can then use the network operation data to train an isolation forest model to detect anomalies and determine anomaly scores for the pre-processed network operations.

At operation 720, the data processing system can determine a subset of network operations as including an anomaly using an isolation forest model. For example, the data processing system can provide the one or more network operations from the training dataset or network operations received after construction of the trees in the isolation forest to determine anomaly scores for each network operation. The data processing system can then classify the network operations with anomaly scores that satisfy an anomaly score threshold as anomalies based on the corresponding anomaly scores. For example, the data processing system can then detect and classify the network operations with anomaly scores that satisfy an anomaly score threshold as anomalies based on the corresponding anomaly scores. In some examples, the data processing system can classify the network operations without regard for whether the network operations are associated with specific types of anomalies (e.g., positive anomalies, negative anomalies, or noise).

At operation 730, the data processing system can be configured to classify and explain the type associated with each network operation. For example, the data processing system can be configured to cluster the network operations processed and scored by the data processing system using the isolation forest. For example, the data processing system can cluster the network operations into one or more clusters and, in some instances, corresponding sub-clusters. In this example, the data processing system can cluster the network operations and perform a cluster analysis to determine aspects about each cluster. For example, the data processing system can determine that one or more network operations assigned to a particular cluster are known to include negative anomalies (e.g., instances of synthetic fraud) and the data processing system can determine that that particular cluster is associated with negative anomalies. The data processing system can likewise determine that network operations are associated with positive anomalies or noise based on the network operations assigned to those clusters.

In some examples, the data processing system can then determine that network operations (included in the training dataset or subsequently-received network operations) are identified as including anomalies are further indicative of positive anomalies, negative anomalies, or noise. For example, the data processing system can determine that the network operations are indicative of positive anomalies, negative anomalies, or noise in response to the data processing system comparing each anomaly to one or more clusters of network operations that are anomalous. In this example, the data processing system can determine that each cluster is associated with network operations that are predetermined as being indicative of positive anomalies, negative anomalies, or noise and that anomalies that are assigned to that cluster indicate the respective anomaly type.

At operation 740, the data processing system can then cause one or more GUIs to be generated. The GUIs can include warning messages identifying network operations or sets of network operations as being positive anomalies, negative anomalies, or noise. The data processing system can then cause a display device in direct communication with the data processing system to generate and display the GUI. In examples, the data processing system can then cause a display device of a client device in communication with the data processing system to generate and display the GUI.

Some embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

While the present disclosure is shown and described with reference to specific embodiments and through one or more examples, it should be understood by those skilled in the art that various changes in form and detail may be made therein without departing from the spirit and scope of the concepts described in this disclosure.

Various descriptions make use of the word “or” to refer to a plurality of alternative options. Such reference is intended to convey an inclusive use of the word “or”. For example, various data processing system components described herein are referenced to as hardware or software components. Such a disclosure indicates that the components can comprise a hardware component, a software component, or both a hardware and a software component.

What is claimed is:

1. A system for isolating network operations processed using a distributed computing environment, the system comprising:
one or more processors configured to:
receive network operation data representing a plurality of network operations processed by a communications network;
classify, using an isolation forest model and the network operation data, a subset of network operations from among the plurality of network operations as comprising an anomaly;
determine, for each network operation of the subset of network operations, that the anomaly is a positive anomaly, a negative anomaly, or noise; and
generate, at a client device, a graphical user interface (GUI) comprising a warning message, the warning message identifying at least one network operation of the subset of network operations as being a negative anomaly.

2. The system of claim 1, wherein the one or more processors is further programmed to:
execute a set of preprocessing operations on the network operation data based on receiving the network operation data;
determine one or more updates to network operations of the plurality of network operations based on the execution of the set of preprocessing operations; and
update the network operation data based on the one or more updates to the network operations.

3. The system of claim 1, wherein the one or more processors configured to classify the subset of network operations is configured to:
provide the network operation data to the isolation forest model to cause the isolation forest model to generate an anomaly score for each network operation, and
determine that each network operation of the subset of network operations has an anomaly score that satisfies an anomaly score threshold; and
determine the subset of network operations based on determining that each network operation satisfying the anomaly score threshold.

4. The system of claim 3, wherein the one or more processors configured to determine, for each network operation of the subset of network operations, that the anomaly is a positive anomaly, a negative anomaly, or noise is configured to:
determine, for each network operation that is associated with a negative anomaly, that the anomaly score corresponds to a cluster associated with negative anomalies, and
wherein the one or more processors configured to generate the GUI comprising the warning message is configured to:
generate the GUI comprising the warning message based on determining that the anomaly score corresponds to the cluster associated with the negative anomalies.

5. The system of claim 4, wherein the one or more processors configured to determine, for each network operation that is associated with a negative anomaly, that the anomaly score corresponds to a cluster associated with negative anomalies is configured to:
determine, for each network operation that is associated with a negative anomaly, that one or more features correspond to a cluster of network operations involving synthetic fraud.

6. The system of claim 3, wherein the one or more processors configured to determine, for each network operation of the subset of network operations, that the anomaly is a positive anomaly, a negative anomaly, or noise is configured to:
determine, for each network operation that is associated with a positive anomaly, that the anomaly score corresponds to a cluster associated with positive anomalies, and
wherein the one or more processors configured to generate the GUI comprising the warning message is configured to:
generate the GUI comprising the warning message based on determining that the anomaly score corresponds to the cluster associated with the positive anomalies.

7. The system of claim 3, wherein the one or more processors is further configured to:
determine a global feature importance (GFI) score and a local feature importance (LFI) score for each feature associated with the isolation forest model; and
determine a plurality of clusters based on the GFI score and the LFI score for each feature associated with the isolation forest model.

8. A method for isolating network operations processed using a distributed computing environment, the method comprising:
receiving, by one or more processors, network operation data representing a plurality of network operations processed by a communications network;
classifying, by the one or more processors and using an isolation forest model and the network operation data, a subset of network operations from among the plurality of network operations as comprising an anomaly;
determining, by the one or more processors and for each network operation of the subset of network operations, that the anomaly is a positive anomaly, a negative anomaly, or noise; and
generating, by the one or more processors and at a client device, a graphical user interface (GUI) comprising a warning message, the warning message identifying at least one network operation of the subset of network operations as being a negative anomaly.

9. The method of claim 8, further comprising:
executing, by the one or more processors, a set of preprocessing operations on the network operation data based on receiving the network operation data;
determining, by the one or more processors, one or more updates to network operations of the plurality of network operations based on the execution of the set of preprocessing operations; and
updating, by the one or more processors, the network operation data based on the one or more updates to the network operations.

10. The method of claim 8, wherein classifying the subset of network operations comprises:
providing, by the one or more processors, the network operation data to the isolation forest model to cause the isolation forest model to generate an anomaly score for each network operation,
determining, by the one or more processors, that each network operation of the subset of network operations has an anomaly score that satisfies an anomaly score threshold; and
determining, by the one or more processors, the subset of network operations based on determining that each network operation satisfying the anomaly score threshold.

11. The method of claim 10, wherein determining that the anomaly is a positive anomaly, a negative anomaly, or noise comprises:
determining, by the one or more processors and for each network operation that is associated with a negative anomaly, that the anomaly score corresponds to a cluster associated with negative anomalies, and
wherein generating the GUI comprising the warning message comprises:
generating, by the one or more processors, the GUI comprising the warning message based on determining that the anomaly score corresponds to the cluster associated with the negative anomalies.

12. The method of claim 11, wherein determining that the anomaly score corresponds to a cluster associated with negative anomalies comprises:
determining, by the one or more processors and for each network operation that is associated with a negative anomaly, that one or more features correspond to a cluster of network operations involving synthetic fraud.

13. The method of claim 10, wherein determining that the anomaly is a positive anomaly, a negative anomaly, or noise comprises:
determining, by the one or more processors and for each network operation that is associated with a positive anomaly, that the anomaly score corresponds to a cluster associated with positive anomalies, and
wherein generating the GUI comprising the warning message comprises:
generating, by the one or more processors, the GUI comprising the warning message based on determining that the anomaly score corresponds to the cluster associated with the positive anomalies.

14. The method of claim 10, further comprising:
determining, by the one or more processors, a global feature importance (GFI) score and a local feature importance (LFI) score for each feature associated with the isolation forest model; and
determining, by the one or more processors, a plurality of clusters based on the GFI score and the LFI score for each feature associated with the isolation forest model.

15. A non-transitory computer-readable medium storing instructions thereon that, when executed by one or more processors, cause the one or more processors to:
receive network operation data representing a plurality of network operations processed by a communications network;
classify, using an isolation forest model and the network operation data, a subset of network operations from among the plurality of network operations as comprising an anomaly;
determine, for each network operation of the subset of network operations, that the anomaly is a positive anomaly, a negative anomaly, or noise; and
generate, at a client device, a graphical user interface (GUI) comprising a warning message, the warning message identifying at least one network operation of the subset of network operations as being a negative anomaly.

16. The non-transitory computer-readable medium of claim 15, wherein the instructions further cause the one or more processors to:
execute a set of preprocessing operations on the network operation data based on receiving the network operation data;
determine one or more updates to network operations of the plurality of network operations based on the execution of the set of preprocessing operations; and
update the network operation data based on the one or more updates to the network operations.

17. The non-transitory computer-readable medium of claim 15, wherein the instructions that cause the one or more processors to classify the subset of network operations cause the one or more processors to:
provide the network operation data to the isolation forest model to cause the isolation forest model to generate an anomaly score for each network operation, and
determine that each network operation of the subset of network operations has an anomaly score that satisfies an anomaly score threshold; and
determine the subset of network operations based on determining that each network operation satisfying the anomaly score threshold.

18. The non-transitory computer-readable medium of claim 17, wherein the instructions that cause the isolation forest model to determine that the anomaly is a positive anomaly, a negative anomaly, or noise cause the one or more processors to:
determine, for each network operation that is associated with a negative anomaly, that the anomaly score corresponds to a cluster associated with negative anomalies, and
wherein the instructions that cause the one or more processors to generate the GUI cause the one or more processors to:
generate the GUI comprising the warning message based on determining that the anomaly score corresponds to the cluster associated with the negative anomalies.

19. The non-transitory computer-readable medium of claim 18, wherein the instructions that cause the one or more processors to determine that the anomaly score corresponds to a cluster associated with negative anomalies cause the one or more processors to:
determine, for each network operation that is associated with a negative anomaly, that one or more features correspond to a cluster of network operations involving synthetic fraud.

20. The non-transitory computer-readable medium of claim 17, wherein the instructions that cause the one or more processors to determine that the anomaly is a positive anomaly, a negative anomaly, or noise cause the one or more processors to:
determine, for each network operation that is associated with a positive anomaly, that the anomaly score corresponds to a cluster associated with positive anomalies, and
wherein the instructions that cause the one or more processors to generate the GUI comprising the warning message cause the one or more processors to:
generate the GUI comprising the warning message based on determining that the anomaly score corresponds to the cluster associated with the positive anomalies.
